(19) United States
(12) Patent Application Publication
(10) Pub. No.: US 2022/0168626 A1
(43) Pub. Date: Jun. 2, 2022

(54) MULTI-GAME MACHINE DISPLAY DEVICE

(71) Applicant: NEXCADE CO., LTD., Seoul (KR)

(72) Inventor: Yong Hwan KIM, Goyang-si Gyeonggi-do (KR)

(21) Appl. No.: 17/436,707

(22) PCT Filed: Mar. 7, 2019
(86) PCT No.: PCT/KR2019/002639

§ 371 Date: Sep. 7, 2021

(51) Int. Cl. A63F 5/00; G07F 17/32; G06Q 50/34

(52) U.S. Cl. CPC A63F 5/007; A63F 5/0076; G06Q 50/34; G07F 17/3209; G07F 17/3288; G07F 17/3211

(57) ABSTRACT

Disclosed is a display device for a multi-game machine. A display device for a multi-game machine configured such that three or more game machines are connected by a network to play each game performs a control operation to display any one or more of a winning probability, a betting score, and a winning score on a display unit as a result of a game, and the display unit is configured to display any one or more of an immediately previous game display window for displaying a winning probability of an immediately previous game or one or more group display windows for displaying winning probabilities of two or more consecutive games including the immediately previous game, thereby having the effect of satisfying an expected demand of a player for a high winning probability and various winning probabilities, and sufficient expectation of various strategies and tactical interventions of the player and winning.

### TECHNICAL FIELD

The present invention relates to a display device for a game machine, and more particularly, a multi-game machine configured to connect one or more online and offline games through a network to display the games on a single display device, and to play a game when the game is selected on the display device.

### BACKGROUND ART

A roulette game, which has attracted attention and interest from many people for centuries, is a type of odds game in which natural numbers 0 to 36 are regularly arranged on a rotatable wheel, a ball is rolled toward the arranged numbers, and winning is recognized according to a set rule when the ball lands on a specific number.

A roulette game wheel is used for the roulette game, and the roulette game wheel is similar to a rotating game wheel on which regular numerical numbers are marked in advance.

The roulette wheel used for the roulette game is divided into American style and European style. From the past to the present, an arrangement of numbers displayed on a surface of the roulette wheel has not changed and has been used as it is.

FIG. 1 illustrates a structure of a roulette wheel 10 for a classic roulette game, and the roulette wheel 10 includes a wheel bowl 11 for guiding rotation, a shaft 12 fixed to a center of the bowl 11, a wheel head 14 having a housing 13 fit to the shaft 12 at a center, rotating around the shaft 12, and having number plates 19 from 0 to 36 arranged at equal intervals and displayed on a surface, separators 17 mounted on the wheel head 14 to have pockets 16 dug at equal intervals to settle a ball 18 at each numerical position, an inclined swash plate 15 mounted around the shaft 12 so that the ball 18 can be freely rolled into any one of the pockets 16, and rotation means for physically turning the wheel head 14 from the outside.

FIG. 2 illustrates an arrangement and an arrangement rule of the numbers displayed on the surface of the roulette wheel 10, and the arrangement and the arrangement rule are indicated by numbers 0 to 36 at equal intervals along a circumferential direction of the wheel head 14. This structure illustrates a model of a European roulette wheel having a single zero digit.

FIG. 3 illustrates an arrangement and an arrangement rule of the numbers displayed on the surface of the roulette wheel 10, and the arrangement and the arrangement rule are indicated by numbers 00 and 0 to 36 at equal intervals along the circumferential direction of the wheel head 14. This structure illustrates a model of an American roulette wheel having two zero digits.

The number plates 19 on the roulette wheel 10 illustrated in FIGS. 2 and 3 have common number arrangements in which odd and even numbers and colors are regularly and continuously alternated, and in the arrangement of numbers, any of the numbers is not duplicated.

In FIG. 2, where the number of zero digits is one, the number 0 is arranged at a point along a circumference of the wheel head 14, and in the case of FIG. 3, where the number of zero digits two, 0 and 00 are arranged side by side on a 180° line with the shaft 12 as a center.

Therefore, in the distribution of numbers 0 to 36 on the arrangement plate of the number plates 19 of the roulette wheel 10, the odd and even numbers are in harmony, and the numbers 0 to 36 other than 0 are set so that the numbers do not overlap.

The order of the game played through the roulette wheel is as follows. First, when the ball is rotated on the rotating wheel in the middle of turning the wheel head 14, the ball 18 rotates along a groove cut in the bowl 11 and then rolls down to the number plates below when the centrifugal force weakens. The ball settles in one of the pockets 16 between separators 17 to indicate any one of the numbers from 0 to 36, where an odd number or an even number is determined. In addition, when section areas of the number plates 19 are marked in red and black, it is determined that a current position of the ball 18 is in either color of red or black. In this way, a predetermined game rule is applied to pay dividends or determine the odds of winning.

Such a conventional roulette game has a problem in that the game does not sufficiently satisfy an expected demand of a player for a winning probability by using only one ball. In other words, the conventional roulette game has the following disadvantage. A player selects a number from among 0 to 36, and a dealer or a player rolls one ball in the opposite direction to the rotating roulette wheel. Then, when the ball falls into a pocket of a certain number on the roulette wheel, a player betting on the number wins. Therefore, in the case of a single number bet, the European type has a uniform winning probability 1/37, and the American type has a uniform winning probability 1/38, so that the game fails to satisfy sufficient expectations for the winning of the roulette game for the player.

In particular, the conventional roulette game has problems of an inaccurate probability, which is governed by the dealer, labor costs incurred by requiring two dealers for one table of roulette, a dispute between a dealer and a customer, a low dividend rate and winning probability, and impossible participation of a large number of people due to limitation of a casino space.

On the other hand, in contrast, an electronic game device has an advantage that a plurality of games can be played through a network or an individual game such as a game medium such as a slot machine, a roulette game device, or a card game device.

The roulette game device, which is one of these electronic game devices, is a device for enjoying a game by betting chips on a win-possible number. A roulette game method is a type of two odds game in which natural numbers 0 to 36 and two colors are regularly arranged on a rotatable wheel, a dealer rolls a ball toward the wheel on which the numbers are arranged, and when the ball settles at a specific number, winning is acknowledged by comparing a number and color bet by a player on a betting board containing numbers with a number and color where the ball is located on the wheel.

However, since the electronic roulette game device provides only an immediate result to a player or provides only a previous result which is not real-time information or real-time information, the player feels that information is insufficient to establish various strategies or tactics.

Accordingly, the player needs a lot of time since the player directly researches necessary information for various strategies or tactics to increase the odds, and then bets on the symbol.

In addition, as network games become possible in a conventional scheme in which garners select and play preferred game machines while walking around to select individual games, the garners can enjoy the game by installing multiple game consoles in front of a single gamer or displaying multiple game consoles. However, there are no conditions for selecting and playing games that are actually being played offline in one place.

In addition, the electronic roulette game device currently in progress has a problem in that a complicated operation is required in a method for betting symbols. Accordingly, the player tries to bet all the numbers in various cases thought by the player to increase the probability of winning in one game. However, it is not easy even for experienced players since the operation for betting is complicated to bet while applying all of strategies and tactics to each game in line with the fast game progress. Due to these difficulties, beginners who are not familiar with the operation of the roulette game device do not have time to use strategies and tactics to further increase the odds of winning, resulting in random bets on almost all games.

This result does not create room for players to intervene in various strategies or tactics, and thus do not meet the expected demand for winning probability, and the players can easily get bored with the game since the game is played in a significantly simple way. Furthermore, naturally, the probability of winning is lowered, causing a problem in which the players lose interest in the game by lowering a will to play.

Due to these problems, the deviation of the players from the roulette game is more and more severe than that of other casino games, and there is an urgent need for a method to solve the problems of the electronic roulette game.

### SUMMARY OF INVENTION

### Technical Problem

An object of the present invention for solving such a problem is to provide a display device for a multi-game machine capable of displaying a betting score, a winning score, and a winning probability using a wheel game.

In addition, another object of the present invention is to provide a display device for a multi-game machine capable of accurately providing information on winning by displaying a betting score, a winning score, and a winning probability and displaying a group display window including a previous game display window and a previous game.

In addition, another object of the present invention is to provide a display device for a multi-game machine allowing several players to simultaneously select one desired game among several games and play the same game or different games using a network.

In addition, another object of the present invention is to provide a display device for a multi-game machine allowing a beginner to find and bet on a game having a high winning rate by applying various strategies and tactics of the player.

In addition, another object of the present invention is to provide a display device for a multi-game machine capable of changing game rules of a classic roulette game to arouse an interest of a participant and increasing a winning rate to enjoy the game with application of various game rules.

### Solution to Problem

A display device of the present invention for a multi-game machine for solving such a problem configured such that three or more game machines are connected by a network to play each game can be achieved by each of the game machines configured to include a wheel plate part that is evenly divided into 55 or fewer zones in sectoral shapes with reference to a center of a circular plate, and includes two or more betting zones in which the 55 or fewer zones are re-divided to have the same or different sizes, a driving unit that rotates the wheel plate part, a ball shooting part that shoots a ball to the rotating wheel plate part, a fixed ball rotation part provided on an outer circumferential surface of the wheel plate part so that the ball shot from the ball shooting part rotates thereon, a display unit that displays a winning probability obtained by dividing a winning score of a previous game by a betting score, a score payment unit that pays a winning score according to a dividend rate when the driving unit is driven to rotate the wheel plate part, the ball shooting part shoots a ball in response to rotation of the wheel plate part, and the ball shot from the ball shooting part rotates on the ball rotation part and then settles on a betting zone of the wheel plate part, and a control unit that performs a control operation to display any one or more of a winning probability obtained by dividing a total winning score by a total betting score, the betting score, and the winning score on the display unit when the winning score is paid by the score payment unit, and the display unit displaying any one or more of an immediately previous game display window for displaying a winning probability of an immediately previous game or one or more group display windows for displaying winning probabilities of two or more consecutive games including the immediately previous game.

In addition, it is preferable that the wheel plate part can be re-divided into nine or fewer betting zones having different dividend rates, and is re-divided into three betting zones.

Further, an input unit that displays a button displaying the number of games or is used to input the number of games is included, and the number of wins is displayed for each betting zone according to the input number of games.

Meanwhile, a display device for a multi-game machine according to another embodiment of the present invention for solving such a problem configured such that three or more game machines are connected by a network to play each game can be achieved by each of the game machines configured to include a wheel plate part evenly divided into 37 or 38 zones in sectoral shapes with reference to a center of a circular plate to sequentially display number arrangement from number “1” to number “36” in a clockwise or counterclockwise direction with reference to “0 or 00”, a driving unit that rotates the wheel plate part, a ball shooting part that shoots a ball to the rotating wheel plate part, a fixed ball rotation part provided on an outer circumferential surface of the wheel plate part so that the ball shot from the ball shooting part rotates thereon, and a control unit that drives the driving unit to rotate the wheel plate part, controls the ball shooting part to shoot a ball in response to rotation of the wheel plate part, and pays a winning score according to a dividend rate as the ball shot from the ball shooting part rotates on the ball rotation part and then settles on a zone of the wheel plate part.

In addition, the game machine is configured to aggregate a bet amount for each betting zone bet on each game machine connected by a network in real time, and display one or more of a betting zone and a bet amount in descending or ascending order of the bet amount on the display unit of each game machine.

Meanwhile, a display device for a multi-game machine according to another embodiment of the present invention for solving such a problem configured such that three or more game machines are connected by a network to play each game can be achieved by each of the game machines configured to include a wheel plate part evenly divided into 55 or fewer zones in sectoral shapes with reference to a center of a circular plate and further re-divided into nine or fewer betting zones having the same or different dividend rates, a driving unit that rotates the wheel plate part, a ball shooting part that shoots a ball to the rotating wheel plate part, a fixed ball rotation part provided on an outer circumferential surface of the wheel plate part so that the ball shot from the ball shooting part rotates thereon, and a control unit that drives the driving unit to rotate the wheel plate part, controls the ball shooting part to shoot a ball in response to rotation of the wheel plate part, and pays a winning score according to a dividend rate as the ball shot from the ball shooting part rotates on the ball rotation part and then settles on a zone of the wheel plate part.

Meanwhile, a display device for a multi-game machine according to another embodiment of the present invention for solving such a problem configured such that three or more game machines are connected by a network to play each game can be achieved by each of the game machines configured to include a score payment unit that pays a winning score according to a dividend rate, a display unit that displays a winning probability obtained by dividing a winning score of a previous game by a betting score, and a control unit that performs a control operation to display any one or more of a winning probability obtained by dividing a total winning score by a total betting score, the betting score, and the winning score on the display unit when the winning score is paid by the score payment unit, and the display unit displaying any one or more of an immediately previous game display window for displaying a winning probability of an immediately previous game or one or more group display windows for displaying winning probabilities of two or more consecutive games including the immediately previous game.

In addition, display of the winning probability by the display unit can be performed on a screen on which the game is being played or another screen.

Further, a display device for a multi-game machine according to another embodiment of the present invention for solving such a problem configured such that three or more game machines are connected by a network to play each game can be achieved by being configured to select and play one or more of a horse racing game, a baccarat game, a card game, and a slot game including a roulette game and a double-up game in which betting is performed while filming game content driven offline and displaying the game content on the game machine in real time.

### Advantageous Effects of Invention

Therefore, according to the display device for the multi-game machine of the present invention, the betting score, the winning score, and the winning probability are displayed, or the previous game display window and the group display window including the previous game are displayed, thereby eliminating the doubt about the inaccurate probability, and solving problems of labor costs due to the presence of dealers, a dispute between a dealer and a customer, a low dividend rate and winning probability, and impossible participation of a large number of people due to limitation of a casino space.

In addition, according to the display device for the multi-game machine of the present invention, different games are displayed together with a conventional manual roulette game and a digital roulette game, so that one desired game can be selected and played. Therefore, there is an effect of being able to select and enjoy a game allowing an expected demand of the player for the winning probability and various strategies or tactical interventions of the player.

In addition, according to the display device for the multi-game machine of the present invention, since it is possible to grasp necessary information for various strategies and tactics to be easily understood, a player can engage in various strategies and tactics of the player. Therefore, there is an effect of satisfying an expected demand of the player for the winning probability and sufficient expectation of winning.

Further, by providing a roulette board different from the conventional one, a plurality of people can select and play the same game or different games based on a network through various games, breaking away from the uniform game. Thus, there is a spatial advantage that there is no limit to the number of players, which is effective in generating profits with maximum effect.

### BRIEF DESCRIPTION OF DRAWINGS

FIGS. 1 to 3 are diagrams illustrating a structure of a roulette wheel for a classic roulette game.

FIGS. 4 and 5 are main configuration diagrams of a display device for a multi-game machine of the present invention.

FIG. 6 is a diagram illustrating a game in progress on a display unit.

FIG. 7 is an example of a game displayed on the display unit when a slot game is selected.

FIG. 8 is a diagram for description of a display device for a multi-game machine using a roulette game machine.

FIGS. 9 and 10 are diagrams illustrating layout of a betting screen displayed on the display unit in a roulette 2 game.

FIG. 11 is a diagram illustrating differently the layout of the betting screen displayed on the display unit in the roulette 2 game.

FIGS. 12 and 13 are diagrams illustrating the layout of the betting screen displayed on the display unit in a double-up game of the present invention.

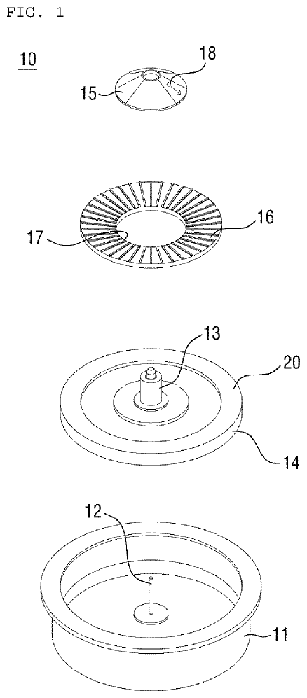

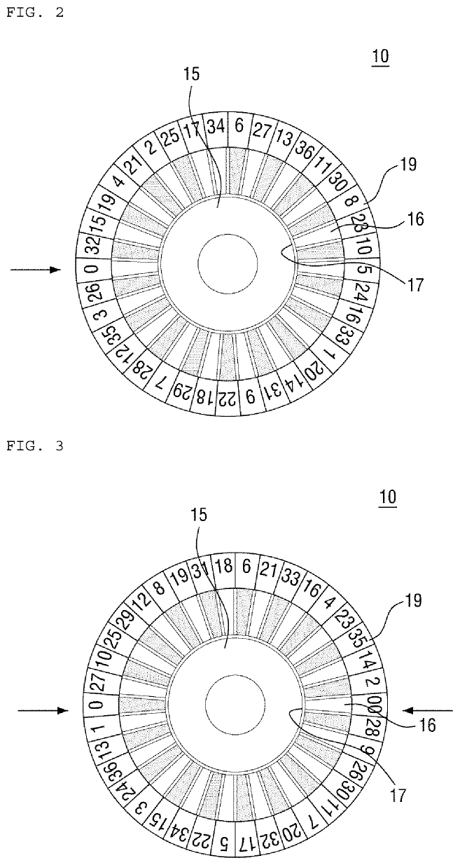

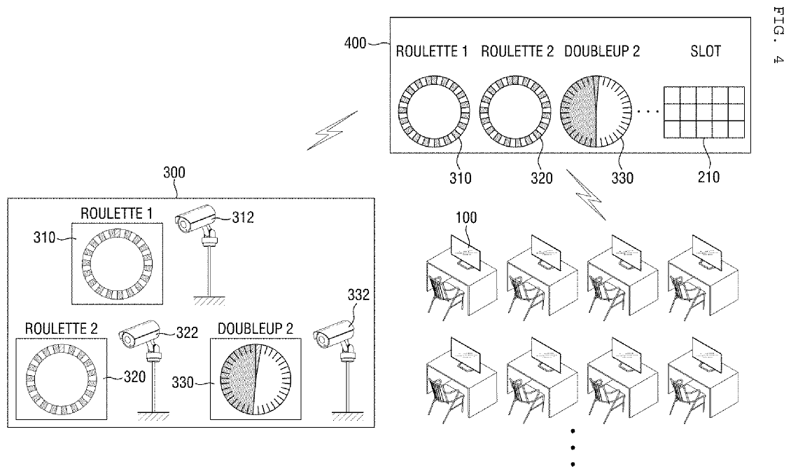

### DESCRIPTION OF EMBODIMENTS

The terms or words used in the present specification and claims are not to be construed as limited in ordinary or dictionary meanings thereof, and need to be interpreted as meanings and concepts consistent with the technical idea of the present invention based on the principle that a concept of a term can be appropriately defined in order to describe the invention of the inventor in the best way.

Throughout the specification, when a part “includes” a certain element, this description means that other elements may be further included, rather than excluding other elements, unless otherwise stated. In addition, each of terms such as “ . . . unit”, “ . . . machine”, “module”, and “device” described in the specification means a unit that processes at least one function or operation, which can be implemented by a combination of hardware and/or software.

Throughout the specification, the term “and/or” should be understood to include all combinations possible from one or more related items. For example, “the first item, the second item, and/or the third item” means not only “the first, second, or third item”, but also a combination of all items that can be presented from two or more of the first, second, or third items.

Hereinafter, an embodiment of the present invention will be described with reference to the drawings.

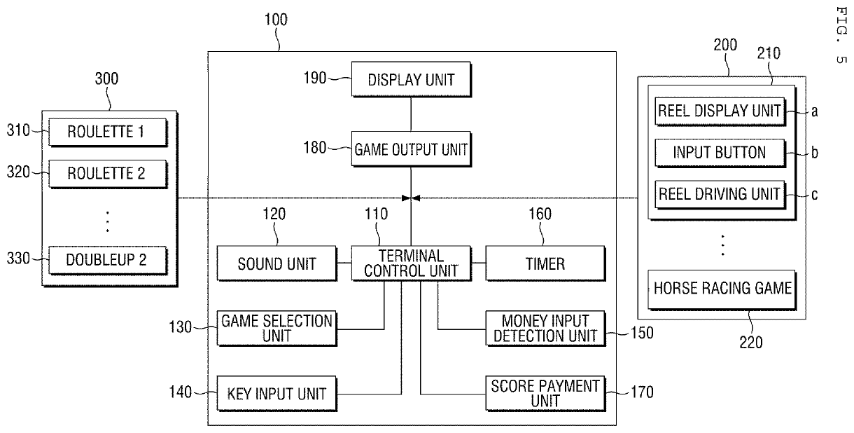

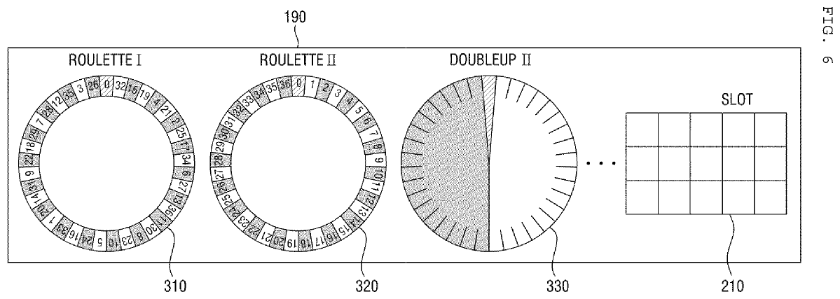

FIGS. 4 and 5 are main configuration diagrams of a display device for a multi-game machine of the present invention, the display device for the multi-game machine of the present invention is configured such that when three or more game machines are connected through a network to display a plurality of the same or different games and any one game is selected in this state, the selected game is played.

To this end, a display device 100 for the multi-game machine of the present invention performs a control operation to proceed with a casino game 300 in which one or more games are played with a participation of a real dealer or players around a game machine offline, a graphically played video game 200, and one game selected by displaying images of the casino game 300 and the video game 200.

More specifically, the display device 100 for the multi-game machine includes a terminal control unit 110 for controlling the game device, a sound unit 120, a game selection unit 130 for selecting a game, a key input unit 140, a money input detection unit 150 for detecting the input of money, a timer 160, a display unit 190 for displaying images of the casino game 300 and the video game 200 and displaying the progress of the game, and a game output unit 180 for outputting the game displayed on the display unit 190.

The sound unit 120 is controlled to output light music in parallel with the progress of the game, and configured to add the effect when displaying the jackpot score, playing a double-up game, or displaying a sound if a bonus game is in progress.

In addition, in order to add a visual effect, lamps driven in various colors may be installed and driven.

The game selection unit 130 is configured to select one game from among games displayed on the display unit 190.

The key input unit 140 includes buttons necessary for the progress of the game.

In particular, in the present invention, a game start button and a button for displaying the number of games or a button for inputting the number of games are provided, and required information can be displayed on the display unit 190 by pressing the required button.

The number-of-games button includes, for example, “all games”, “1 to 10”, “1 to 20” . . . “1 to 100”, etc. When the corresponding button is pressed, for example, when the button “1 to 20” is pressed (meaning previous 20 games including an immediately previous game), the terminal control unit 110 performs a control operation to display one or more of a winning probability obtained by dividing a total of winning scores by a total of betting scores, a betting score, and a winning score on the display unit 190.

In addition, the number of wins for each number during the corresponding game can be displayed.

Further, input means such as a number key is included in the key input unit 140, and when a number is input to input the number of games, the terminal control unit 110 may display the number of wins for each betting zone within the input number of games.

As the money input detection unit 150, it is possible to apply a well-known sensor that detects the input of coins or medals through a coin inlet, or a known banknote sensing device for detecting the input of banknotes or substitute banknotes through a banknote slot or a card reader.

The timer 160 displays a remaining betting time or the progress of the remaining betting time as a graph or a number.

In the present invention, the casino game 300 may include all games actually made in the casino. However, in the present invention, for convenience of description, a conventional roulette game (ROULETTE I, hereinafter referred to as “roulette 1”) 310, roulette II having a different combination of numbers from that of the conventional roulette (ROULETTE II, hereinafter referred to as “roulette 2”) 320, and double-up (DOUBLE UP II) 330 are played, and images of the corresponding game captured by respective cameras 312, 322, and 332 are transmitted to players connected by a network so that the players can participate in the game remotely.

In addition, in the present invention, a video game means a game machine in which a game is displayed graphically instead of a reel on an individual machine device, and such a game may be a horse racing game, a baccarat game, a card game, or a slot game. In addition, naturally, it is possible to display the same game as a game operated offline as a graphic to proceed.

That is, the casino game 300 and the video game 200 may be the same game or different games.

Meanwhile, the display device 400 provides convenience by installing games provided from the casino game 300 and the video game 200 on a large screen at a center of a game room so that the progress of several games can be recognized at a glance.

Referring to FIG. 4, it can be seen that the conventional roulette 1 310, the roulette 2 320 having a different combination of numbers from that of the conventional roulette, the double-up (DOUBLE UP II) 330, and a slot game 210 are displayed on the display device 400.

The terminal control unit 110 displays, on the display unit 190, one or more casino games 300 obtained by photographing a game in progress at a casino site and the video game 200 operated graphically. When any one of the games displayed on the display unit 190 is selected through the game selection unit 130, the terminal control unit 110 performs a control operation so that the corresponding game is played while the corresponding game is displayed on the display unit 190.

For example, when the player selects the slot (SLOT) game 210 from the game displayed on the display unit 190, the terminal control unit 110 performs a control operation to display a scene related to the progress of the slot (SLOT) game 210 on a screen according to the progress speed of the slot (SLOT) game 210.

Although omitted from the drawings, it is natural that such graphics, that is, the content of the video game may be stored in a separate DB or memory.

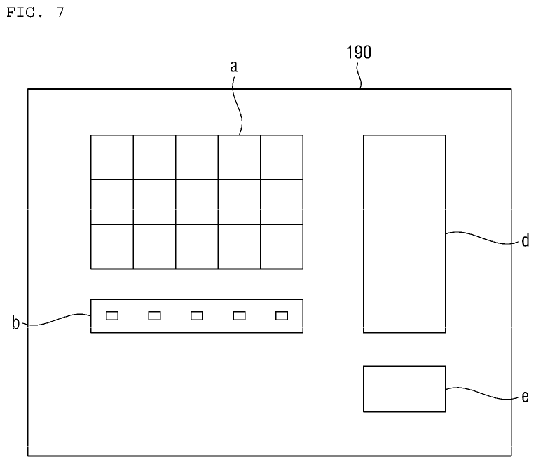

In the view illustrating the game in progress on the display unit of FIG. 6, when the slot game 210 is selected by touching the screen, in the case of selecting the slot game of FIG. 7, the terminal control unit 110 performs a control operation to display a game progress scene related to the slot game as in the example of the game displayed on the display unit.

Referring to the figure, a reel display unit a is disposed on the display unit 190, and an input button b is configured on one side of the reel display unit a (in the figure, a lower side of the reel display unit).

In addition, the reel display unit a may display images or characters necessary for the game. In the present embodiment, the reel characters with 15 patterns (characters) are configured to have an arrangement of vertical*horizontal=3*5, and each reel character is variably displayed by driving of a reel driving unit c.

The input button b may include betting buttons on which different bet amounts are displayed so that the bet amount can be set.

When the bet amount is selected through the input button b, the terminal control unit 110 is operated to simultaneously rotate reels of a reel display unit where the bet amount is selected and of a reel display unit where the bet amount is not selected and simultaneously stop the reels after a predetermined time elapses, and then add and pay winning scores according to a dividend rate when it is determined that a pattern of a reel character stopped on the reel display unit for which the bet amount is selected is contained in preset winning line in a certain number of more.

The above-described slot game exemplifies a reel game machine, and exemplifies one of video games that can be configured with graphics.

Therefore, it is natural that not only the reel game but also a horse racing game, a baccarat game, and a card game can be configured.

In addition, a score payment unit 170 operates so that a wheel plate part 321 rotates, a ball shooting part 322 shoots a ball in response to rotation of the wheel plate part 321, and a winning score is paid according to a dividend rate when the ball shot from the ball shooting part 322 rotates on a ball rotation part 20 and then settles in a betting zone of the wheel plate part.

When the winning score is paid from the score payment unit 170, the terminal control unit 110 performs a control operation to display, on the display unit 190, any one or more of a winning probability obtained by dividing a total of winning scores by a total of betting scores, a betting score, and a winning score.

When display devices 100 of two or more multi-game machines, that is, several game machines are connected by a network, the terminal control unit 110 aggregates in real time the amount of bets for each betting zone bet on each game machine connected to the network, so that any one or more of a betting zone and a bet amount may be displayed on the display unit of each game machine in the descending or ascending order of the bet amounts.

In addition, the display unit 190 may display the winning score, the betting score, and the winning probability obtained by dividing the winning score by the betting score of the previous game.

As such a winning probability, it is possible to display a previous game display window displaying a winning probability of an immediately previous game or one or more group display windows displaying winning probabilities of two or more consecutive games including the immediately previous game.

These specific indications will be described in detail below.

Reference symbol 220 not described denotes a horse racing game among video games.

Hereinafter, with reference to the drawings, games of the roulette 2 (ROULETTE I) 320 and the double-up (DOUBLE UP II) 330 newly constructed in the present invention will be described.

As described above, it is obvious that the roulette 2 (ROULETTE II) 320 and the double-up (DOUBLE UP II) 330, which are classified as casino games, are actually played offline and the corresponding image may be displayed on the display unit 190 as an image or the game may be played as a graphic game, such as a video game.

From a point of view of the player, casino games and video games are played in the same manner, and thus a method of playing the game will be mainly described below with respect to a casino game.

In addition, the roulette game machine can be merely divided into the roulette 1 (ROULETTE I) 310 game using the conventional number plates and the roulette 2 (ROULETTE) 320 game having a different configuration of the number plates according to the configuration of the wheel plate part, and other components are the same. A component having the same configuration as that of the conventional technology will be denoted by the same reference symbol, and a detailed description thereof will be omitted.

First, the configuration of the wheel plate part will be described with reference to FIG. 6.

In FIG. 6, the roulette game is a layout drawn on a betting table for describing an example of a game through a distribution of numbers arranged on the roulette wheel and colors divided into black and red.

Since the figure needs to be displayed in black and white, the red color is colorless and the black color is marked with hatching or shading to distinguish the colors from each other.

The wheel plate part 321 is evenly divided into 55 or fewer zones in sectoral shapes with reference to a center of a circular plate, and includes two or more betting zones in which the 55 or fewer zones are re-divided to have the same or different sizes.

That is, this description means that the wheel plate part may include 55 betting zones when 55 equal zones are used and include fewer than 55 betting zones when grouping with the same or different sizes.

In the present invention, the betting zone is divided into 55 or fewer zones instead of the existing 36 or 37 zones to increase the winning probability of the player.

For example, in the case of dividing into the existing 36 betting zones including “0”, when betting on all the respective betting zones, the winning probability is about 97.3% (=(36/37)*100)). However, in the case of dividing into a total of 55 zones, the winning probability is about 98.2% (=(54/55)*100). Thus, it is possible to provide a higher winning probability than that of conventional games. Therefore, there is an effect of making the players more active in the game.

That is, when the wheel plate part is divided into 55 zones, the wheel plate part may be evenly divided into 55 betting zones marked 0 and numbers 1 to 54 or into 53 betting zones marked 0 and 00, and numbers 1 to 54 and displayed.

Therefore, in the case of including 54 equal betting zones, the arrangement of numbers may be the same as before.

Alternatively, the numbers “1” to “54” may be sequentially displayed in a clockwise or counterclockwise direction with reference to “0 or 00”.

Referring to FIG. 6, it can be seen that the numbers can be arranged by dividing the wheel plate part into 37 betting zones marked 0 and numbers 1 to 36.

Since the conventional wheel plate part includes 36 pieces with reference to “0 or 00”, the numbers are arranged to use the same wheel plate part.

Further, referring to the figures, each number are distinguished from adjacent number by using red and black.

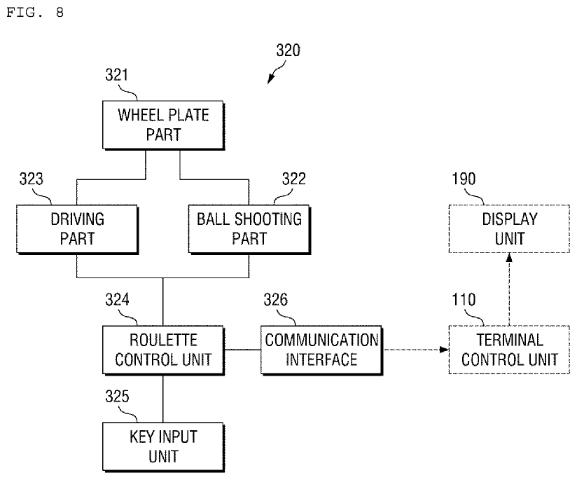

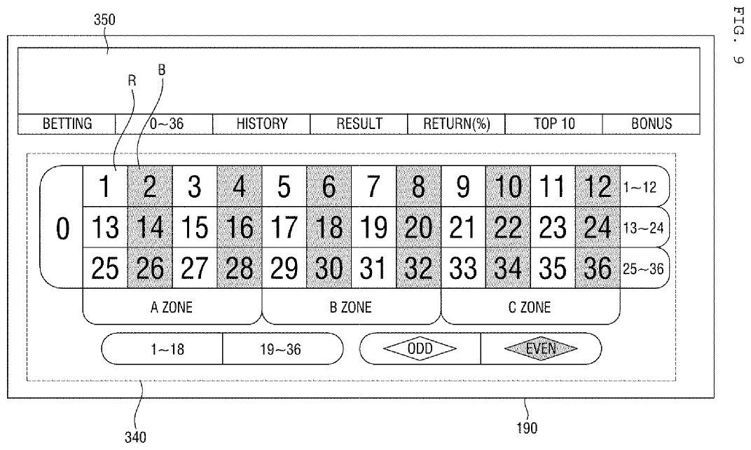

Referring to the figure for describing the display device for the multi-game machine using the roulette game machine of FIG. 8, the display device for the multi-game machine using the roulette game machine of the present invention includes the wheel plate part 321 having two or more betting zones obtained by evenly dividing the part into 55 or fewer zones in a sectoral shape with reference to the center of the circular plate and re-dividing the 55 or fewer zones to have the same or different sizes, a driving unit 323 for rotating the wheel plate part 321, the ball shooting part 322 for shooting a ball to the rotating wheel plate part 321, and fixed ball rotation part 20 provided on an outer circumferential surface of the wheel plate part 321 to rotate the ball shot from the ball shooting part 322.

In addition, the display device for the multi-game machine using the roulette game machine of the present invention includes a key input unit 325 necessary for game progress, and a roulette control unit 324 that performs a control operation so that the driving unit 323 is driven to rotate the wheel plate part 321 in response to transmission of a start signal from the key input unit 325 and the ball shooting part 322 shoots a ball in an opposite direction or the same direction to or as a rotation direction of the wheel plate part 321 after a predetermined time elapses.

In addition, the roulette control unit 324 communicates with the terminal control unit 110 of each game terminal through the communication interface 326 to transmit the game progress, betting details, etc.

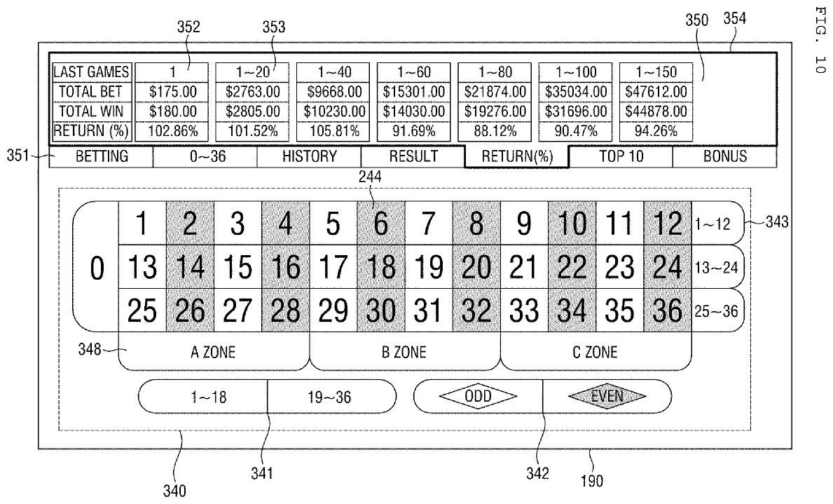

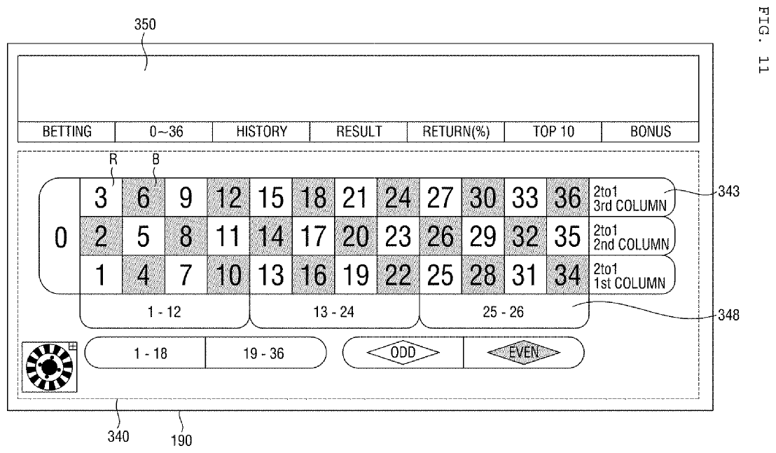

When the player selects the roulette game, the terminal control unit 110 receiving the game progress causes an image transmitted from a camera to be displayed on an edge of the display unit 190, and causes a betting screen illustrated in FIGS. 9 and 10 to be displayed on the display unit 190.

Simply put, the roulette game corresponds to a probability of guessing numbers, and thus it is possible to predict that the probability does not change even when the numbers are arranged in order of 12349, which reduces interest since various game rules of the roulette game cannot be applied.

Therefore, as in FIGS. 9 and 10, the betting screen displayed on the display unit 190 is divided into an information window 350 displaying the winning probability, etc. and a betting board 340. The information window 350 is configured in the form of a horizontal bar in an upper part of the screen, and the betting board 340 is configured in a lower part of the information window 350 to easily select a desired number and bet.

First, referring to the betting board 340, 36 numbers are divided into three equal parts, each of which has 12 numbers.

The first number on the left is marked with “0”, and a first column line has betting zones 1 to 12 divided into odd and even numbers and displayed with different background colors.

A second column line has betting zones 13 to 24 divided into odd and even numbers and displayed with different background colors, and a third column line has betting zones 25 to 36 divided into odd and even numbers and displayed with different background colors.

Here, R represents red and B represents black.

Specifically, the first line is assigned with {1R 2B 3R 4B 5R 6B 7R 8B 9R 10B 11R 12B},

the second line is assigned with {13R 14B 15R 16B 17R 18B 19R 20B 21R 22B 23R 24B},

the third line is assigned with {25R 26B 27R 28B 29B 30R 31B 32R 33B 34R 35B 36R}, and each line has six Rs and six Bs.

Therefore, all colors R are configured as odd numbers, and all colors B are configured as even numbers.

Among 36 numbers, a dozen bet 345 is divided into three dozens of <A ZONE> corresponding to numbers 1, 2, 3, 4, 13, 14, 15, 16, 25, 26, 27, and 28, <B ZONE> corresponding to numbers 5, 6, 7, 8, 17, 18, 19, 20, 29, 30, 31, and 32, and <C ZONE> corresponding to numbers 10, 11, 12, 13, 21, 22, 23, 24, 33, 34, 35, and 36, and thus distribution of each number needs to be evenly divided in the number display section. Further, this description is similarly applied to a row bet 343 having three rows, each of which has 12 numbers, a number 1 row (1 to 12) including a number 1 line, a number 2 row (13 to 24), and a number 3 row (25 to 36).

In addition, a half bet 341 including a button <1 to 18> for selecting numbers 1 to 18 and a button <19 to 36> for selecting numbers 19 to 36 is displayed.

In addition, an odd and even selection button (Odd and Even Bet) 342, etc. may be displayed.

In the present invention, odd numbers are displayed in red and even numbers are displayed in black.

It is possible to set the layout differently from that of the above-described betting board.

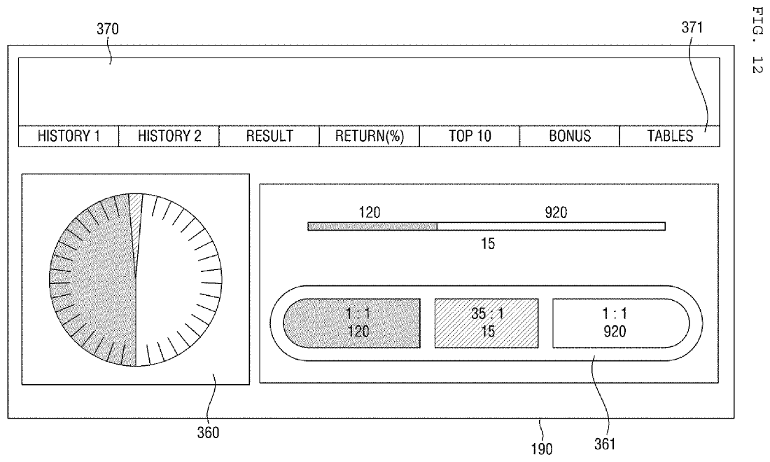

This layout shows that a configuration illustrated in FIG. 11 can be constructed so that the player can easily select a desired betting combination while viewing necessary information.

Referring to the figure that differently exemplifies the layout of the betting screen displayed on the display unit in the roulette 2 game of FIG. 11, a first digit on the left is marked as “0”, and DOZEN 1 to 12 zones 348 displays 1 to 12 betting zones divided into odd and even and displayed with different background colors.

DOZEN 13 to 24 zones 348 displays 13 to 24 betting zones divided into odd and even and displayed with different background colors, and DOZEN 25 to 36 zones 348 displays 25 to 36 betting zones divided into odd and even and displayed with different background colors.

Here, R represents red and B represents black.

Specifically, the DOZEN 1 to 12 zones 348 are assigned with {1R 2B 3R 4B 5R 6B 7R 8B 9R 10B 11R 12B},

the DOZEN 13 to 24 zones 348 are assigned with {13R 14B 15R 16B 17R 18B 19R 20B 21R 22B 23R 24B},

the DOZEN 25 to 36 zones are assigned with {25R 26B 27R 28B 29B 30R 31B 32R 33B 34R 35B 36R}, and each line has six Rs and six Bs.

Therefore, all colors R are configured as odd numbers, and all colors B are configured as even numbers.

Among the 36 numbers, COLUMN BET is divided into a “1”st column, a “2”nd column, and a “3”rd column. Further, the “1”st column includes 1, 4, 7, 10, 13, 16, 19, 22, 25, 28, 31, and 34, the “2”nd column includes 2, 5, 8, 11, 14, 17, 20, 23, 26, 29, 32, and 35, and the “3”rd column includes 3, 6, 9, 12, 15, 18, 21, 24, 27, 30, 33, and 36.

In addition, the half bet 341 including the button <1 to 18> for selecting numbers 1 to 18 and the button <19 to 36> for selecting numbers 19 to 36 is displayed.

In addition, the odd and even selection button (Odd and Even Bet) 342, etc. may be displayed.

That is, the betting board screen in the present invention does not limit the layout as long as it includes the above-described betting buttons.

Further, it is possible to display a general betting button (1 at once) for betting on one zone using a special button, a “34 at once” button for betting on remaining 34 numbers excluding three numbers around a touched number, a “32 at once” button for betting on remaining 32 numbers excluding five numbers around the touched number, a “30 at once” button for betting on remaining 30 numbers excluding seven numbers around the touched number, etc.

When the number arrangement on the betting board 340 is biased, and the odd numbers, the same colors, or the dozen and column numbers are clustered or bundled, the rules of the roulette game are not applied probabilistically, so that interest may be reduced, and it may be read in advance. Therefore, a normal game may not be played. Accordingly, as in FIGS. 9 and 10, it can be seen that regardless of whether there is one “0” or “00” is or is not present, the number plates placed on the surface of the wheel plate part are arranged under a maximum condition that arouses interest in application of the game rules, that is, so that odd and even numbers, colors, dozens, column numbers, etc. are marked without clustering and alternately in horizontal, vertical, and diagonal directions.

In other words, in the conventional roulette game 310, the numbers 0 to 36 are arranged on the wheel plate part according to a certain rule, which has not been changed for centuries and are still applied today. However, as described above, a difference is found between whether there is one number of “0” and whether “00” is marked in the arrangement of numbers on the roulette wheel in European and American styles. Such a change can be considered to bring some changes to the application of the rule of the roulette game.

In addition, even though a basic rule of the classic roulette game has been maintained until now, odd and even numbers, position and color of numbers, etc. showed a low winning rate and was not suitable for various roulette games, it was not possible to double the interest of the game by applying various roulette game methods, a combination of the number plates on the roulette wheel was incomplete, and thus it was inappropriate to enjoy the roulette game for entertainment and leisure. Moreover, since the roulette wheel has been used without change for centuries, the rules and methods of the game have not changed, requiring a change in various rules or forms of the roulette game.

The betting screen of the present invention is used to display, in the same manner, a betting board configured to bet on a roulette game device that is performed offline. As a figure character containing the same number as the number displayed on the wheel, numbers from 0 to 36 and letters are displayed on a column type betting board. Therefore, by using the betting board including numbers arranged in a column on the display unit 190, the player predicts a symbol (number, letter, color, etc.) where the ball will be located on the wheel, and bets chips on the symbol.

At this time, before determining which symbol to bet on, the player may intervene in his various strategies or tactics to increase the winning probability, thereby determining which symbol is expected to have a high winning rate. That is, the player may determine the symbol while observing the past winning results in the roulette game, the symbols continuously displayed on the wheel, and the betting situation of other players as determining factors for determining the symbol to bet.

These marks are configured to be close to the maximum condition that odd and even numbers, colors, dozens, and column numbers do not cluster and alternate in horizontal, vertical, and diagonal directions, so that the roulette game, which has been applied unchanged for centuries, can undergo rearrangement of numbers and change in positions and colors to diversify the game method and induce sufficient interest.

Referring to the roulette 2 320 of FIG. 6, it can be seen that the wheel plate part is divided into 37 equal zones, each zone is set as a betting zone, and numbers “1” to “36” are sequentially arranged and displayed in the clockwise direction with reference to “0” in the respective betting zone.

Alternatively, the wheel plate part may be divided into 37 equal zones, and numbers “1” to “36” may be sequentially arranged and displayed in the counterclockwise direction with reference to “0” in the betting zones.

Alternatively, the wheel plate part may be evenly divided into 38 betting zones including “0” and “00” and marked from numbers 1 to 36 and displayed, and numbers “1” to “36” may be sequentially displayed in the clockwise or counterclockwise direction with reference to “0” or “00”.

Referring to the figure, the background color of odd-numbered betting zones such as 1, 3, 5, and 7 is indicated in red, and the background color of even-numbered betting zones is indicated in black, and “0” is indicated in green.

Meanwhile, referring to the double-up II (DOUBLEUP II, 330) of FIG. 6, as in the roulette 2 320, the wheel plate part is roughly divided into 37 equal zones, and the betting zones are distinguished by three colors.

That is, this description means that the wheel plate part of the roulette 1 is used, and nine or fewer betting zones are included. However, in the figure, one that is configured to include three betting zones and separately include colors is referred to as the double-up 2.

In the figure, the betting zone (hatched area) marked with the number “0” is displayed in green, the background color of the area of numbers “1” to “18” is colorless in the figure and is actually displayed in red, and the background color of the area of numbers “19” to “36” is shaded in the figure and is actually displayed in black.

The division of the area means the difference in the dividend rates in the end. In the figure, it can be seen that the dividend rate of the number “0” is 36 times and the dividend rates of red and black are “½”, respectively.

Using this principle, a double-up game can be formed by re-dividing into nine betting zones with different dividend rates.

That is, the color of each betting zone may be displayed differently for each dividend rate in order to visually distinguish the difference in dividend rate easily.

Double-up II of FIG. 6 is a case in which the actual dividend rates of red and black are the same, and are displayed in red and black so that bets can be separately placed on the left and right.

Hereinafter, the operation of the display device for the above-described multi-game machine will be described.

First, the games currently being played on the display device for each game machine connected to the network are displayed on the display unit 190.

The games displayed on the display unit may be the same type of games as described above or different games. Alternatively, some games may be the same games and the other others may be different games. Alternatively, the games may be an image of a game that is actually being played offline or a game constructed graphically.

As illustrated in FIG. 6, when a player selects a game desired to be played from the games displayed on the display unit 190, the terminal control unit 110 displays content of the game on the display unit 190.

When the player selects the roulette 2 320 in the game displayed on the display unit 190, the terminal control unit 110 controls the roulette control unit 324 to start the game by controlling the roulette game.

The roulette control unit 324 transmits a screen for betting on the corresponding game or a screen such as a past game history to the terminal control unit 110 to display the screen on the display unit 190.

As such a screen, as in the figure illustrating the layout of the betting screen displayed on the display unit of FIGS. 9 and 10, numbers 1 to 36 including “0” are distinguished and arranged in even and odd numbers.

That is, the betting board for the roulette 2 is displayed as described above.

In the roulette 2 of the present invention, a circular plate may be evenly divided into 37 or 38 zones in sectoral shapes, and number arrangement may be sequentially displayed from number “1” to number “36” in the clockwise or counterclockwise direction with reference to “0 or 00”. However, in the present invention, the wheel plate part is sequentially marked from number “1” to number “36” in the clockwise direction with reference to “0”. Therefore, the betting zones are arranged as illustrated in FIG. 9 to satisfy the maximum condition that can interest the application of the game rules, that is, odd, even, color, dozen, and column numbers do not crowd each other and are marked so that the numbers can alternate in the left and right, up and down, and diagonal directions.

In addition, when the terminal control unit 110 displays game-related information on the initial display unit 190 as in FIGS. 9 and 10, no display may be performed on the information window 350 as in FIG. 9. However, as in FIG. 10, RETURN (%) can be displayed.

There may be information display buttons 351 in the form of a horizontal bar at the bottom of the information window 350, and these display buttons include “BETTING, 0 to 36, HISTORY, RESULT, RETURN, TOP 10, or BONUS” buttons, which are displayed and operate to perform the corresponding function in response to the corresponding button being touched.

It is obvious that the button can be configured as a touch button type.

Referring to FIG. 9, the information window 350 is configured in the form of a horizontal bar in the upper part of the screen, and the betting board 340 is displayed for each betting zone so that a desired number can be easily selected and bet on in the lower part of the information window 350.

In the case of recording and displaying a game in progress at an actual casino, etc., betting needs to be completed within the same time as the betting time being made offline. Therefore, if necessary, such a betting board may be connected to the game machine and display a remaining time using a timer to report betting time information.

When the information display button 351 is pressed, the corresponding information is displayed on the information window 350.

Among the information display buttons 351, the “BETTING” button displays the betting status of the game being played. When the “BETTING” button is selected, the betting zone and bet amount on the same betting board as the betting board at the bottom of the “BETTING” button in each game machine linked to the network are aggregated in real time, and the betting zones are sequentially displayed from left to right in descending order of the bet amount. In other words, when the “BETTING” button is selected while the roulette “1” betting board is displayed on a specific game machine, the bet amount for each betting zone for betting on the roulette game “1” from each game machine linked to the network is aggregated in real time, and the betting zones are displayed in descending or ascending order of the bet amounts on the information window of the game machine where the “BETTING” button is selected.

The “0 to 36” button displays the number of winnings for each betting zone within a certain number of games only for the game machine for which the “0 to 36” button is selected, sorted in ascending or descending order. That is, when a certain number of games are selected on a specific game machine, it is possible to know how many times the numbers 0 to 36 have been won.

The “HISTORY” button displays a winning record of the corresponding game machine during a certain game.

The “RESULT” button displays a winning area and a winning result of the last 20 games bet by the player in the game machine.

The “RETURN” button displays a winning probability by number of games in 1 to 10,000 games of the corresponding game machine.

The “TOP 10” button displays the winning status of the first to tenth place of the game machine in units of 1, 7, and 30 days, which can be checked by winning score and winning time.

In addition, the “BONUS” button displays the winning record of the LUCKY BONUS of the game machine from 1 to 50, and the winning time, game machine type, and winning details.

The number of games is input through a button where the number of games is displayed or an input unit in addition to these information display buttons to check information.

At this time, as described above, if necessary, the bet amount for each betting zone bet on each game machine connected to the network may be aggregated in real time, and at least one or more of the betting zone and the bet amount can be displayed in descending or ascending order of the bet amounts on the display unit 190.

As described above, when the necessary information is displayed on the information window 350 to confirm and then the betting is completed, the progress of the game is displayed on the display unit 190 when the game start button of the key input unit 140 is pressed or, in the case of a game displaying an image, when the game is started on the actual game machine.

First, when the game is started, the terminal control unit 110 may display the roulette 2 320 game of FIG. 6 on the display unit 190 through the game output unit 180 on the entire screen or display the progress of the roulette 2 on a small screen on one side of the screen of the betting board 340.

In addition, even when displaying a video shot of an actual game machine, the video can be displayed on the full screen of the roulette 2 (320) game, or the progress of the roulette 2 can be displayed on a small screen on one side of the screen of the betting board 340.

When roulette is selected, the game process may proceed as follows.

First, the roulette control unit 324 drives the driving unit 323 to rotate the wheel plate part 321, and the ball shooting part 322 is controlled to shoot the ball to the rotating wheel plate part.

When the ball shot from the ball shooting part 322 rotates along the ball rotation part 20 provided on the outer circumferential surface of the wheel plate part 321 and then settles on the betting zone of the wheel plate part due to deceleration of the rotation speed, the winning score may be awarded according to the dividend rate.

In this case, when the winning score is awarded according to the dividend rate through the score payment unit 170, the terminal control unit 110 performs a control operation to display at one or more of the winning probability obtained by dividing the total of the winning score by the total of the betting score, the betting score, and the winning score on the display unit 190.

In addition, it is possible to display a previous game display window displaying the winning probability of the previous game or one or more group display windows displaying the winning probability of two or more consecutive games including the previous game on the display unit 190.

In FIG. 10, when the “RETURN(%)” button among the information display buttons 351 is touched, “PREVIOUS GAME”, “TOTAL BET”, “TOTAL WIN” and “RETURN(%)” are displayed in order in the left column of the information window 350, so that “PREVIOUS GAME” indicates a type of game displaying information, “TOTAL BET” indicates the total bet amount of the previous game, “TOTAL WIN” indicates the total winning amount, and “RETURN(%)” indicates the winning probability.

Referring to the figure, the information window 350 displays a previous game display window 352 for displaying a winning probability of the previous game and one or more group display windows 353 for displaying winning probabilities of two or more consecutive games including the previous game.

The previous game display window 352 displays “1” indicating the previous first game, the total bet amount of $175, the winning amount of $180, and the winning probability (RETURN) of 102.86%.

The group display window 353 displays the total bet amount, the total winning amount, and the winning probability displayed as 101.52% for the last 19 games including the previous game, that is, games 1 to 20.

Thereafter, information on games 1 to 40, games 1 to 80, games 1 to 100, and games 1 to 150 may be displayed in the group display windows 353 on the information window 350.

In the present invention, the group display window 353 is configured to display information about a plurality of set games (1, 1 to 10, 1 to 20, 1 to 30, etc.) including the previous game. However, a game section can be set and displayed.

That is, it is possible to perform setting by entering a number such as games 2 to 18 without including the previous game.

Meanwhile, when the player selects the double-up 2 330 in the game displayed on the display unit 190, the roulette control unit 324 displays a screen on which a corresponding game can be bet or a screen such as a past game history on the display unit 190 by transmitting the screen to the terminal control unit 110.

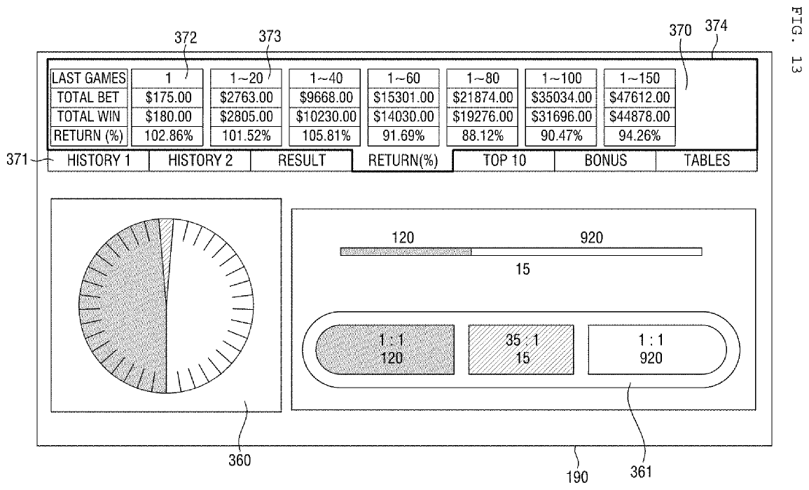

Referring to the figures illustrating the layout of the betting screen displayed on the display unit in the double-up game of the present invention of FIGS. 12 and 13, the information window 370 is displayed on the upper part, and the information display button 351 is displayed on the lower part of the information window 370 in the form of a horizontal bar.

A “BETTING” button, a “HISTORY2” button, a “RESULT” button, a “RETURN(%)” button, a “TOP 10” button, a “BONUS” button, and a “TABLES” button are displayed in the information display button 351 of the double-up 2, and the corresponding information is displayed on the information window 370 in response to the corresponding button being touched. Since this display method is the same as that of the roulette 2, a detailed description thereof will be omitted.

On the lower left side of the display unit 190, the wheel plate part 360 used for the double-up 2 may be displayed, and the betting board 361 may be displayed on the right side thereof.

The wheel plate part 360 is exemplified by the wheel plate part in a state in which the betting zone is re-divided into three parts.

In the present embodiment, the color according to the betting zone includes three parts. However, in practice, as in the roulette 2 320, the wheel plate part is divided into approximately 37 zones, and the betting zone is distinguished by three colors.

That is, in the drawing, the betting zone (hatched area) marked with the number “0” is displayed in green. In the area of numbers “1” to “18”, the background color is colorless in the drawing, but is actually displayed in red. In the area of numbers “19” to “36” are areas in which the background color is shaded in the drawing, but is actually displayed in black.

The betting board 361 on the right displays the betting status for three colors.

In the case of recording and displaying a game that is being played in an actual casino, etc., betting needs to be completed within the same time as the offline betting time. Thus, if necessary, the betting board may be connected to a game machine to display a remaining time using a timer to report betting time information.

When the information display button 371 is pressed, the corresponding information is displayed on the information window 370.

The number of games may be input through a button displaying the number of games or an input unit in addition to these information display buttons to check information.

At this time as well, as described above, if necessary, the bet amount for each betting zone bet on each game machine connected to the network may be aggregated in real time, and at least one of the betting zone and the bet amount may be displayed on the display unit 190 in descending or ascending order of the bet amounts.

As described above, necessary information is displayed on the information window 370 to be checked, and then, when the betting is completed, the progress of the game is displayed on the display unit 190.

First, when the game is started, the terminal control unit 110 may display the double-up 2 game illustrated in FIG. 12 on the display unit 190 through the game output unit 180 on the full screen or display the progress of the double-up 2 on a small screen on one side of the screen of the betting board 361.

In addition, when displaying images that captured game contents or roulette performed offline, the corresponding image may be displayed on the entire screen of the display unit 190 or the progress of the double-up 2 may be displayed on a small screen on one side of the screen of the betting board 361.

The case of selecting the double-up 2 is almost the same as the roulette 2, and a brief description is as follows.

First, the roulette control unit 324 drives the driving unit 323 to rotate the wheel plate part 321, and controls the ball shooting part 322 to shoot the ball to the rotating wheel plate part.

When the ball shot from the ball shooting part 322 rotates along the ball rotation part 20 provided on the outer circumferential surface of the wheel plate part 321 and then settles on the betting zone of the wheel plate part due to deceleration of the rotation speed, the dividend rate is calculated according to the color of the betting zone on which the ball settles and the winning score is awarded.

In this case, when the winning score is awarded according to the dividend rate through the score payment unit 170, the terminal control unit 110 performs a control operation to display one or more of the winning probability obtained by dividing the total of the winning score by the total of the betting score, the betting score, and the winning score on the display unit 190.

In addition, it is possible to display a previous game display window displaying the winning probability of the previous game or one or more group display windows displaying the winning probability of two or more consecutive games including the previous game on the display unit 190.

In FIG. 13, when the “RETURN(%)” button among the information display buttons 351 is touched, “PREVIOUS GAME”, “TOTAL BET”, “TOTAL WIN” and “RETURN(%)” are displayed in order in the left column of the information window 350, so that “PREVIOUS GAME” indicates a type of game displaying information, “TOTAL BET” indicates the total bet amount of the previous game, “TOTAL WIN” indicates the total winning amount, and “RETURN(%)” indicates the winning probability.

Referring to the figure, the information window 370 displays a previous game display window 372 for displaying a winning probability of the previous game and one or more group display windows 373 for displaying winning probabilities of two or more consecutive games including the previous game.

The previous game display window 372 displays “1” indicating the previous first game, the total bet amount of $175, the winning amount of $180, and the winning probability (RETURN) of 102.86%.

The group display window 373 displays the total bet amount, the total winning amount, and the winning probability displayed as 101.52% for the last 19 games including the previous game, that is, games 1 to 20.

Thereafter, information on games 1 to 40, games 1 to 80, games 1 to 100, and games 1 to 150 may be displayed in the group display windows 373 on the information window 370.

In the present invention, the group display window 373 is configured to display information about a plurality of set games (1, 1 to 10, 1 to 20, 1 to 30, etc.) including the previous game. However, a game section can be set and displayed.

That is, it is possible to perform setting by entering a number such as games 2 to 18 without including the previous game.

Since general game rules can be applied to other games such as horse racing games, baccarat games, card games, etc., detailed descriptions thereof will be omitted.

Using the above configuration, the present invention can operate the game machine by selecting various operating methods.

That is, there is a method in which only a roulette game is played by changing the configuration of the wheel plate part, or a game is played by connecting to other games by a network.

First, as a roulette game in which the wheel plate part of the roulette is evenly divided into 55 or fewer zones and the 55 or fewer zones are re-divided into parts having the same or different sizes to configure two or more betting zones and using this configuration, 1) one or more may be installed and operated as stand alone, 2) a video may be taken and displayed on the display unit of each game machine to play the game on a plurality of game machines, or 3) the roulette game and other games may be loaded on one game machine so that one of desired games may be selected and played.

In addition, for each game operating method, only the configuration of the roulette is different and operating methods of other games are the same. Therefore, only different representative games are described in each game operating method to avoid overlapping descriptions.

In this game, game 3) among games 1) to 3) will be described in detail.

In game 3), the wheel plate part including two or more betting zones evenly divided into 55 or fewer zones in sectoral shapes with reference to the center of the circular plate and further re-divided into parts having the same or different sizes, the driving unit that rotates the wheel plate part, the ball shooting part that shoots the ball to the rotating wheel plate part, the ball rotation part, the display unit that displays the winning probability obtained by dividing the winning score of the previous game by the betting score, and the score payment unit that pays the winning score according to the dividend rate are included, and at least one or more of a previous game display window displaying a winning probability of an immediately previous game or one or more group display windows displaying winning probabilities of two or more consecutive games including the immediately previous game are displayed on the display unit.

Second, as a roulette game in which the wheel plate part is evenly divided into 37 or 38 zones in sectoral shapes with reference to the center of the circular plate, and number arrangement may be sequentially displayed from number “1” to number “36” in the clockwise or counterclockwise direction with reference to “0 or 00”, 1) one or more may be installed and operated as stand alone, 2) a video may be taken and displayed on the display unit of each game machine to play the game on a plurality of game machines, or 3) the roulette game and other games may be loaded on one game machine so that one of desired games may be selected and played.

Among these games, the game 2) will be described in detail. It is possible to include the wheel plate part evenly divided into 37 or 38 zones in sectoral shapes with reference to the center of the circular plate, in which number arrangement is sequentially displayed from number “1” to number “36” in the clockwise or counterclockwise direction with reference to “0 or 00”, the driving unit that rotates the wheel plate part, the ball shooting part that shoots the ball to the rotating wheel plate part, the ball rotation part, and the control unit that drives the driving unit to rotate the wheel plate part, controls the ball shooting part to shoot a ball in response to rotation of the wheel plate part, and pays the winning score according to the dividend rate as the ball shot from the ball shooting part rotates on the ball rotation part and then settles on a zone of the wheel plate part.

Third, as a double-up game in which the wheel plate part of the roulette is evenly divided into 55 or fewer zones with reference to the center of the circular plate and re-divided into nine or fewer betting zones having the same or different dividend rates and using this configuration, 1) one or more may be installed and operated as stand alone, 2) a video may be taken and displayed on the display unit of each game machine to play the game on a plurality of game machines, or 3) the roulette game and other games may be loaded on one game machine so that one of desired games may be selected and played.

In this game, game 1) among games 1) to 3) will be described in detail.

Included are the wheel plate part evenly divided into 55 or fewer zones in sectoral shapes with reference to the center of the circular plate and further re-divided into nine or fewer betting zones having the same or different dividend rates, the driving unit that rotates the wheel plate part, the ball shooting part that shoots the ball to the rotating wheel plate part, the fixed ball rotation part provided on the outer circumferential surface of the wheel plate part so that the ball shot from the ball shooting part rotates thereon, and the control unit that drives the driving unit to rotate the wheel plate part, controls the ball shooting part to shoot a ball in response to rotation of the wheel plate part, and pays the winning score according to the dividend rate as the ball shot from the ball shooting part rotates on the ball rotation part and then settles on a zone of the wheel plate part.

In this case, the wheel plate part may be divided into three betting zones, and colors of the respective betting zones may be displayed in green, red, and black to constitute the wheel plate part.

That is, as illustrated in FIGS. 12 and 13, the betting zone can be divided into three parts and the double-up 2 game can be played.

Fourth, it is possible to select an operating method in which three or more game machines are connected through a network, one or more game machine record and display a live-action game running offline, at least one or more other game machines create and display a game in software, that is, graphically, and any one of the games is selected to play the game.

That is, in this method, while filming game content driven offline and displaying the game content on the game machine in real time, one or more of a horse racing game, a baccarat game, a card game, and a slot game including a roulette game and a double-up game in which betting is performed are displayed, and a game is selected and played.

In this case, a game may be selected by providing a selection button allowing selection of any one from three or more games to the key input unit 140, or touching any one of the games displayed on the display unit 190 as illustrated in FIG. 6.

In this case, it is natural that any one of the roulette games may be played by arranging one of, simultaneously, or a plurality of one or more of a roulette in which number arrangement of the wheel plate part is the same as that of a conventional structure and roulette 2 games of the present invention using the wheel plate part in which numbers are sequentially arranged in one direction.

In addition, the same game may be played offline or by displaying two or more games including graphics. When any one of the existing games is selected, an information window and an information display button are displayed on the display unit 190 as described above, and information necessary for the game can be displayed to operate the game more effectively.

Even though the present invention has been described in detail with respect to the described embodiments, it is apparent to those skilled in the art that various modifications and variations are possible within the scope of the technical spirit of the present invention, and it is natural that such variations and modifications belong to the appended claims.

### INDUSTRIAL APPLICABILITY

The present invention enables a game to be played when any one game is selected from among games displayed on a display device. In a game room, several games can be connected to a network and displayed, and the corresponding game can be played by selecting the displayed game. Thus, it is possible to dispel doubts about inaccurate probability, and to solve a problem that a large number of people are not allowed to participate due to limitation of a casino space. Accordingly, players enjoy the game, and operators can generate revenue.

1. A display device for a multi-game machine configured such that three or more game machines are connected by a network to play each game,
wherein each of the game machines comprises:
a wheel plate part that is evenly divided into 55 or fewer zones in sectoral shapes with reference to a center of a circular plate, and includes two or more betting zones in which the 55 or fewer zones are re-divided to have the same or different sizes;
a driving unit that rotates the wheel plate part,
a ball shooting part that shoots a ball to the rotating wheel plate part;
a fixed ball rotation part provided on an outer circumferential surface of the wheel plate part so that the ball shot from the ball shooting part rotates thereon;
a score payment unit that pays a winning score according to a dividend rate when the driving unit is driven to rotate the wheel plate part, the ball shooting part shoots a ball in response to rotation of the wheel plate part, and the ball shot from the ball shooting part rotates on the ball rotation part and then settles on a betting zone of the wheel plate part; and
a control unit that performs a control operation to display any one or more of a betting score, and a winning score,
a button for displaying the number of games, and
an input unit for displaying the number of games,
wherein the control unit arranges and displays buttons for displaying the number of games in units of 10 or in units of 100 in order on one side of the display unit, and displays the number of winnings for each betting zone within the input number of games on the display unit when any one of the buttons for displaying the number of games is input, or displays the number of winnings for each betting zone within the input number of games when the number of games is input through the input unit.

2. The display device of claim 1, wherein the wheel plate part is displayed by being evenly divided into 37 betting zones marked 0 and numbers 1 to 36, or 38 betting zones marked 0, 00, and numbers 1 to 36.

3. The display device of claim 2, wherein the wheel plate part has arrangement of the numbers sequentially displayed from number “1” to number “36” in a clockwise or counterclockwise direction in the betting zones.

4. The display device of claim 1, wherein the wheel plate part is divided into nine or fewer betting zones, and while displaying colors of the betting zones differently for each dividend rate, the number of people participating in a bet or a bet amount for each betting zone is displayed as a number or a bar graph.

5.-6. (canceled)

7. The display device of claim 1,
wherein the display unit displays one or more group display windows displaying winning scores of two or more consecutive games including an immediately previous game while displaying a winning probability obtained by dividing a total winning score of a previous game by a total betting score.

8.-9. (canceled)

10. The display device of claim 1, wherein the multi game machine aggregates a bet amount for each betting zone bet on each game machine connected by a network in real time, and displays one or more of a betting zone and a bet amount in descending or ascending order of the bet amount on the display unit of each game machine.

11.-25. (canceled)

26. A display device for a multi-game machine configured such that three or more game machines are connected by a network to play one game selected by a display unit,
wherein the game machine
includes a score payment unit that pays a winning score according to a dividend rate, and
a display unit that displays a winning probability obtained by dividing a winning score of a previous game by a betting score,
simultaneously displays, on the display unit, an offline game filming a roulette game or a double-up game in progress in real time offline, and one or more video games among horse racing game, a baccarat game, a card game, and a slot game, and
displays, on the display unit, a game screen for playing one game in response to the game being selected among the games displayed on the display unit through a selection button,
the roulette game includes
a wheel plate part displayed by being evenly divided into 37 betting zones marked 0 and number 1 to number 36 or 38 betting zones marked 0, 00, and number 1 to number 36 in sectoral shapes with reference to a center of a circular plate,
a driving unit that rotates the wheel plate part,
a ball shooting part that shoots a ball to the rotating wheel plate part,
a fixed ball rotation part provided on an outer circumferential surface of the wheel plate part so that the ball shot from the ball shooting part rotates thereon, and
a score payment unit that pays a winning score according to a dividend rate when the driving unit is driven to rotate the wheel plate part, the ball shooting part shoots a ball in response to rotation of the wheel plate part, and the ball shot from the ball shooting part rotates on the ball rotation part and then settles on a betting zone of the wheel plate part,
the game machine includes a control unit that performs a control operation to display any one or more of a winning probability obtained by dividing a total winning score by a total betting score, the betting score, and the winning score on the display unit when the winning score is paid by the score payment unit,
the display unit displays one or more group display windows displaying winning probabilities of two or more consecutive games including an immediately previous game, and
the winning probability is displayed on a screen on which the game is being played or another screen.

27. The display device of claim 26, comprising
a button for displaying the number of games,
wherein the control unit arranges and displays buttons for displaying the number of games in units of 10 or in units of 100 in order on one side of the display unit, and displays the number of winnings for each betting zone within the number of games on the display unit when any one of the buttons for displaying the number of games is pressed.

28. The display device of claim 26, comprising
an input unit for inputting the number of games,
wherein the control unit displays the number of winnings for each betting zone within the input number of games on the display unit when the number of games is input through the input unit.

29. The display device of claim 28, wherein the wheel plate part sequentially displays a number arrangement from number 1 to number 36 displayed in the betting zone in a clockwise or counterclockwise direction.

30. (canceled)

31. The display device of claim 26,
wherein the double-up game includes
a wheel plate part evenly divided into 55 or fewer zones in sectoral shapes with reference to a center of a circular plate and further re-divided into nine or fewer betting zones having the same or different dividend rates,
a driving unit that rotates the wheel plate part,
a ball shooting part that shoots a ball to the rotating wheel plate part,
a fixed ball rotation part provided on an outer circumferential surface of the wheel plate part so that the ball shot from the ball shooting part rotates thereon, and
a control unit that drives the driving unit to rotate the wheel plate part, controls the ball shooting part to shoot a ball in response to rotation of the wheel plate part, and pays a winning score according to a dividend rate as the ball shot from the ball shooting part rotates on the ball rotation part and then settles on a zone of the wheel plate part.

32. The display device of claim 31,
wherein the double-up game and the baccarat game display the number of people participating in a bet for each title or a bet amount for each betting zone as a number or a bar graph.

33. (canceled)

34. The display device of claim 26, wherein the multi-game machine aggregates a bet amount for each betting zone bet on each game machine connected by a network in real time, and displays one or more of a betting zone and a bet amount in descending or ascending order of the bet amount on the display unit of each game machine.
